(19) United States
(12) Patent Application Publication
(10) Pub. No.: US 2019/0327893 A1
(43) Pub. Date: Oct. 31, 2019

(54) HEADER FLOAT AND SKID PLATE ADJUSTMENT

(71) Applicant: AGCO Corporation, Duluth, GA (US)

(72) Inventors: Kevin J. Hamilton, Hesston, KS (US); Robert L. Figger, Hesston, KS (US)

(21) Appl. No.: 16/462,148

(22) PCT Filed: Oct. 25, 2017
(86) PCT No.: PCT/IB2017/001291

§ 371 Date: May 17, 2019

Related U.S. Application Data
(60) Provisional application No. 62/423,380, filed on Nov. 17, 2016.

(51) Int. Cl. A01D 41/14; A01D 78/00

(52) U.S. Cl. CPC A01D 41/141; A01D 69/03; A01D 78/001

(57) ABSTRACT

In one embodiment, a machine, comprising: a chassis supporting a hydraulic float assembly, the hydraulic float assembly comprising first plural cylinders and a first control component; a header coupled to the hydraulic float assembly, the header comprising: a frame comprising processing components on an upper side of the frame and plural skid plates on a lower side of the frame, the plural skid plates adjustably coupled to the frame via respective second plural cylinders; and a controller configured to: receive a first input; and provide a first signal to a second control component coupled to the second plural cylinders based on the first input, the second control component configured to adjust fluid flow through the second plural cylinders based on the first signal, the second plural cylinders causing adjustment of a position of the plural skid plates based on the adjusted fluid flow.

### TECHNICAL FIELD

The present disclosure is generally related to agricultural machines and, more particularly, self-propelled rotary windrowers.

### BACKGROUND

Self-propelled windrowers may be equipped with rotary headers that, during field operations, are typically operated in a manner where the header is lightly contacting the ground in what is referred to as a floating operation. To set the floating pressure, the operator engages the hydraulic float assembly or spring assembly while the windrower is stationary to lift the header slightly off the ground surface, and once that point is observed by the operator to occur, the operator scales back (e.g., by one setting interval, such as hundred (100) lbs. or as desired) the pressure setting for the hydraulic float assembly. The floating operations of the windrower minimize the drag as the header is pushed along the ground. In addition, the rotary headers are often equipped with manually adjustable metal or poly (plastic) skid shoes or skid plates that serve as a contact point or points between a ground surface and the bottom of the header. Certain field crop conditions may also warrant adjustment of the skid plates, which in turn adjusts how high the header rests on the ground. An improved mechanism for handling the header operating configuration is desired.

### BRIEF DESCRIPTION OF THE DRAWINGS

Many aspects of certain embodiments of a header adjust system can be better understood with reference to the following drawings. The components in the drawings are not necessarily to scale, emphasis instead being placed upon clearly illustrating the principles of the present systems and methods. Moreover, in the drawings, like reference numerals designate corresponding parts throughout the several views.

FIG. 1 is a schematic diagram that illustrates, in front perspective view, an example machine in which an embodiment of a header adjust system may be implemented.

FIG. 2 is a schematic diagram that illustrates, in front elevation view, an example machine comprising a hydraulic float assembly for an embodiment of a header adjust system.

FIG. 3 is a schematic diagram that illustrates certain components used in operations of a header adjust system for an example machine.

FIG. 4A is a schematic diagram that illustrates, in rear elevation, fragmentary view, plural skid plates and corresponding skid plate actuators in an embodiment of a header adjust system.

FIG. 4B is a schematic diagram that illustrates, in right side elevation, fragmentary view, one of the skid plates and corresponding skid plate actuator in an embodiment of a header adjust system.

FIG. 5A is a block diagram that illustrates an example control system for an embodiment of a header adjust system.

FIG. 5B is a block diagram of an embodiment of an example controller used in the control system of FIG. 5A

FIG. 6 is a flow diagram that illustrates an embodiment of an example header adjust method.

### DESCRIPTION OF EXAMPLE EMBODIMENTS

### Overview

In one embodiment, a machine, comprising: a chassis supporting a hydraulic float assembly, the hydraulic float assembly comprising first plural cylinders and a first control component; a header coupled to the hydraulic float assembly, the header comprising: a frame comprising processing components on an upper side of the frame and plural skid plates on a lower side of the frame, the plural skid plates adjustably coupled to the frame via respective second plural cylinders; and a controller configured to: receive a first input; and provide a first signal to a second control component coupled to the second plural cylinders based on the first input, the second control component configured to adjust fluid flow through the second plural cylinders based on the first signal, the second plural cylinders causing adjustment of a position of the plural skid plates based on the adjusted fluid flow.

### Detailed Description

Certain embodiments of a header adjust system and method are disclosed that provide for automated adjustment of skid plate position (e.g., height) for a windrower header, monitoring of skid plate loads for float control, and automated adjustment of float pressure for a self-propelled windrower. In one embodiment, each skid plate is adjustably coupled to the header by an actuator (e.g., rod and piston linear cylinder, rotary actuator, motor, etc.). The actuator is coupled to a control component (e.g., control valve, including air valve, solenoid valve, motor control circuitry, etc.), the control component controlled by a controller. For instance, the controller receives an input and, based on the input, causes the actuator to adjust the position of the skid plate without the need for an operator to leave a cab of the windrower. In some embodiments, the actuator may have a sensor coupled thereto, or integrated within the actuator, which upon detection of a parameter, including force on the skid plate or distance or change in gap between the skid plate and a ground surface, triggers the adjustment of the float pressure. For instance, in implementations where the operator sets the float pressure of the header, the operator may activate the hydraulic float cylinders to begin lifting the header, and upon the sensor detecting that the header is off the ground surface, the sensor signals to the controller, which in turn causes the float setting adjustment. In effect, once the float setting operation is set in motion, the operator need not be actively involved in configuring the float setting. In some implementations, feedback by the sensor of skid plate loads provides for more effective control of header float pressure and prevention or mitigation skid plate excessive wear.

Digressing briefly, conventional windrowers have skid plates that may be manually adjusted. For instance, the operator may activate, from the cab of the windrower, the lifting of the header to provide access to the skid plates, and then leave the cab to adjust the skid plates. For instance, for each skid plate, the operator may pull a pin from fixed, slotted brackets to enable the manual raising or lowering of the skid plate. In some circumstances, the task of adjusting the skid plates may expose the operator to mud, crop material, or other less-than-favorable environmental conditions, and by requiring the operator to leave the cab, efficiency in operations may be hampered or safety of the operator compromised. Also, float pressure adjustment on the windrowers today is a manual process that correlates with the skill and/or experience of the operator. For instance, the operator relies on his visual perception of when the header has been lifted from the surface of the ground, and the setting may not be performed correctly, potentially resulting in excessive wear on the skid plates. Further, field operations and/or machine issues may result in the need for adjustment of the float pressure, wherein the need may go un-noticed by the operator, potentially resulting in less efficient operations and/or potentially excessive wear on the skid plates. To address these shortcomings, certain embodiments of a header adjust system use actuators and/or header sensors that may mitigate operator error, provide timely responsiveness to changed circumstances, and/or mitigate the labor or risk of injury for the operator, providing efficiency, cost savings, and a safer working environment for swathing operations.

Having summarized certain features of a header adjust system of the present disclosure, reference will now be made in detail to the description of a header adjust system as illustrated in the drawings. While an example header adjust system will be described in connection with these drawings, there is no intent to limit it to the embodiment or embodiments disclosed herein. For instance, though emphasis is placed on a machine in the agricultural industry, and in particular, a self-propelled windrower with a rotary header, certain embodiments of a header adjust system may be beneficially deployed with other headers and/or in other machines (in the same or other industries) that use a header with skid plates (or skid shoes) that require adjustment and/or that require a proper operational setting for a coupled header or benefit from real-time monitoring of loads on the header. As another example, emphasis is placed on using a skid plate actuator embodied as a linear-acting cylinder operating under dynamic hydraulic fluid flow (e.g., hydraulic rod and piston cylinder), with flow to and from the cylinder controlled by a control component embodied as a control valve (e.g., having a electromechanical control component that controls a spool or poppet for adjusting a fluid flow interface, such as a paddle, ball, globe, or disc). However, in some embodiments, the skid plate actuator may comprise a rotary actuator and/or actuators using different control components and/or principles (e.g., pneumatic actuator, electric or electromagnetic actuator, magnetic actuator, motor, etc.). Further, although the description identifies or describes specifics of one or more embodiments, such specifics are not necessarily part of every embodiment, nor are all of any various stated advantages necessarily associated with a single embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

Note that references hereinafter made to certain directions, such as, for example, “front”, “rear”, “left” and “right”, are made as viewed from the rear of the windrower looking forwardly.

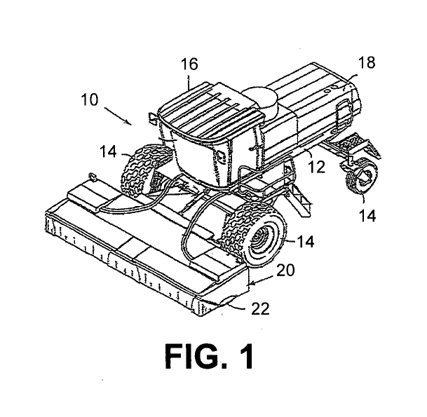

Reference is made to FIG. 1, which illustrates an example agricultural machine for which an embodiment of a header adjust system may be implemented. One having ordinary skill in the art should appreciate in the context of the present disclosure that the example agricultural machine, depicted in FIG. 1 as a self-propelled windrower 10, is merely illustrative, and that other machines and/or components with the need to maintain proper loading on the header may deploy certain embodiments of a header adjust system in some embodiments. The windrower 10 is operable to mow and collect standing crop in the field, condition the cut material as it moves through the machine to improve its drying characteristics, and then return the conditioned material to the field in a windrow or swath. The windrower 10 may include a chassis 12 supported by wheels 14 (although tracks may be used in some embodiments, or other configurations in the number and/or arrangement of wheels may be used in some embodiments) for movement across a field to be harvested. The chassis 12 supports a cab 16, within which an operator may control or activate certain operations of the windrower 10 including header lift, float setting, or skid plate adjustment, and a rearwardly spaced compartment 18 housing a power source (not shown) such as an internal combustion engine. The chassis 12 also supports a ground drive system that, in one embodiment, when powered by the engine, causes differential rotation of the wheels (e.g., increasing the speed of one wheel while decreasing the speed of the opposite wheel) according to a dual path steering mechanism as is known in the art. In some embodiments, other mechanisms for enabling navigation and/or traversal of the field may be used.

A coupled working implement, depicted in FIG. 1 as a harvesting header 20, is supported on the front of the chassis 12 using a hydraulic float assembly, as described further below. The header 20 may be configured as a modular unit and consequently may be disconnected for removal from the chassis 12. As is known in the art, the header 20 has processing components on an upper side of the header 20 (e.g., a laterally extending crop cutting assembly 22 in the form of a low profile, rotary style cutter bed located adjacent the front of the header 20) for severing crop from the ground as the windrower 10 moves across a field. Beneath the header 20 are plural skid plates (obscured from view in FIG. 1) that are coupled to the header frame and which help to reduce the drag of the header, protect the bottom of the header surface from wear, and set the height of the header 20 as it rests on the ground. One skilled in the art will understand that other types of crop cutting assemblies 22, such as sickle style cutter beds, may also be used in some embodiments.

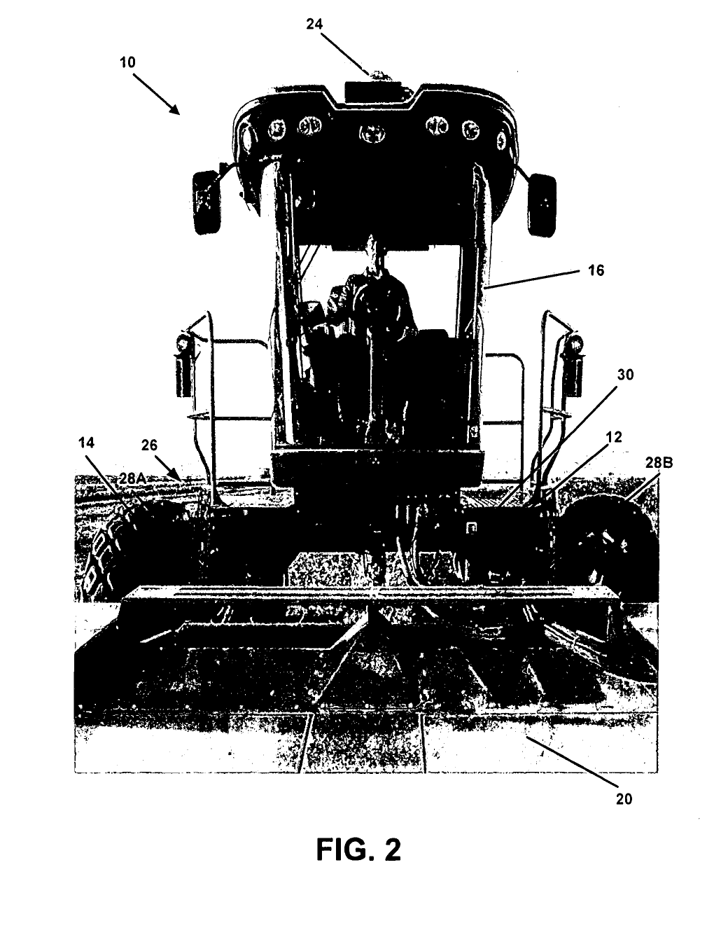

Referring now to FIG. 2, shown is a schematic diagram that illustrates, in front elevation view, the example windrower 10 in which an embodiment of a header adjust system may be implemented. The windrower 10 comprises the cab 16. The cab 16 is supported by the chassis 12. The cab 16 further comprises one or more sensors, including a global navigation satellite systems (GNSS) receiver 24, which when combined with a steering system and guidance software, enables satellite guided traversal through the field. The windrower 10 further comprises a hydraulic float assembly 26 that includes two hydraulic cylinders 28 (e.g., 28A, 28B) that couple to respective lift arms that in turn couple to the header 20. The hydraulic float assembly 26 also comprises a rock shaft 30 that extends laterally to the direction of forward motion of the windrower 10. The rock shaft 30 is partially rotated by its own hydraulic cylinder (not shown) and is also coupled operably to the arms of the hydraulic cylinders 28 in known manner. The hydraulic cylinders 28, with some assistance from the rock shaft 30, causes the raising and lowering of the header 20 (e.g., such as at headlands), and the adjustment of fluid flow through the hydraulic cylinders 28 results in the adjustment and locked-in setting of the float pressure and hence floating action of the header 20.

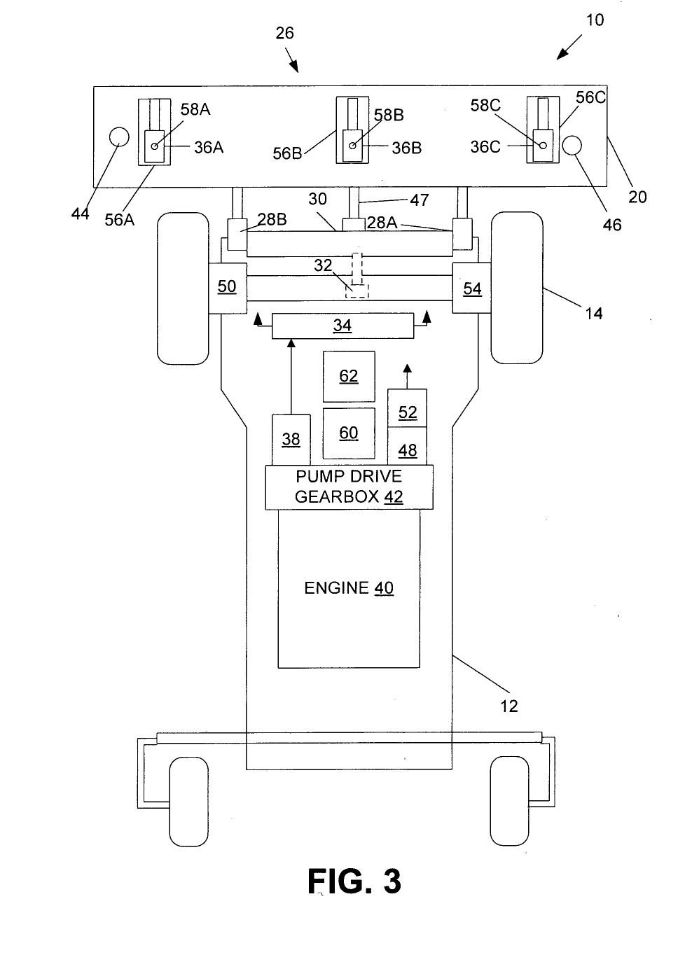

Attention is now directed to FIG. 3, which shows the example windrower 10 in fragmentary, overhead plan (schematic) view. It should be appreciated, within the context of the present disclosure, that the example windrower 10 depicted in FIG. 3 is merely illustrative of one design, and that other designs (or other machines) may likewise provide a suitable environment for embodiments of a header adjust system with beneficial effect. As shown (with certain well-known features omitted for brevity and clarity), the windrower 10 is generally depicted with the header 20 and the chassis 12, which is coupled to the header 20 and to the wheels 14. In one embodiment, the windrower 10 supports the hydraulic float assembly 26, which comprises the hydraulic cylinders 28A and 28B and the rock shaft 30 with its own hydraulic cylinder 32. The hydraulic cylinders 28 and 32 are coupled via fluid conduits (e.g., hoses, tubing, etc.) to a manifold 34. The manifold 34 comprises one or more control valves, each having a control portion (e.g., solenoid valve) that is activated (e.g., electronically) to adjust a valve spool or poppet to drive a disc, ball, globe, paddle, or other fluid interfacing component to control the flow of fluid (e.g., hydraulic fluid) into and out of the control valve. The control of the fluid flow at the manifold 34 in turn controls the flow of fluid into and out of ports of the hydraulic cylinders 28, 32, enabling actuation, which raises, lowers, or sets/adjusts the floating position of the header 20. The control valves of the manifold 34 are also referred to herein as control components. The manifold 34 may also control the flow of hydraulic fluid into and out of the skid plate actuators 36 (36A, 36B, and 36C) when the actuators are embodied as hydraulic fluid actuators (e.g., rod and piston style, linear actuators). As indicated above, the skid plate actuators 36 may be embodied as other types of actuators, including rotary style actuators or actuators based on pneumatic, electric/electromagnetic, or other principles. The manifold 34 is also coupled to a header drive/control pump 38, which is driven based on operations of an engine 40 and a pump drive gearbox 42 as is known, and which in turn provides the hydraulic pressure for the down stream devices or components. In some embodiments, more than one manifold may be used.

The windrower 10 and/or its component parts may comprise additional, fewer, and/or different subsystems. For instance, the header 20 comprises header drive motors 44 and 46 (though some embodiments may have fewer or additional motors), which may be coupled to the manifold 34 and/or the header drive pump 38. Also shown is a center hydraulic cylinder 47, which may form part of the hydraulic float assembly 26 to provide additional header adjust functionality. The windrower 10 also comprises a ground drive system that is powered by the engine 40 and pump drive gearbox 42. In one embodiment, the ground drive system further comprises a left wheel propel pump 48 coupled to the pump drive gearbox 42, and further coupled to a left wheel drive motor 50 via hydraulic fluid lines. The ground drive system also comprises a right wheel propel pump 52 coupled to the pump drive gearbox 42, and further coupled to a right wheel drive motor 54 via hydraulic fluid lines. The hydraulic fluid lines from the left and right wheel propel pumps 48, 52 are collectively represented by the single-headed arrow emanating from the pump 52. Although depicted as comprising a by-wire system, other hydraulic mechanisms may be used to facilitate ground transportation in some embodiments, and hence are contemplated to be within the scope of the disclosure.

The windrower 10 also comprises plural skid plates 56 (e.g., 56A, 56B, and 56C) located proximal to opposing ends beneath (but adjustably coupled to) the header 20 and in the middle of the header 20. The skid plates 56 are associated with respective skid plate actuators 36 (e.g., 36A, 36B, 36C). Note that the skid plates 56 and skid plate actuators 36 are not actually shown in an overhead plan perspective, but merely shown as schematic representations to convey their general location relative to the header 20. In some embodiments, the locations may be different and/or a different quantity of skid plates 56 may be used. In one embodiment, the windrower 10 comprises one or more sensors 58 (e.g., 58A, 58B, and 58C) coupled to, or integrated with, the skid plate actuators 36A, 36B, and 36C, respectively, and one or more controllers, such as controller 60. In some embodiments, the sensors 58 may be located elsewhere (e.g., not coupled to the skid plate actuators 36), and in some embodiments, additional sensors or fewer sensors may be used. In one embodiment, the sensors 58 detect a parameter, including force or load on the skid plates. In some embodiments, the sensors 58 may be used to detect a different and/or additional parameter, including a distance or change in gap between the bottom of the header 20 or bottom of the skid plates 56 and the ground surface. The sensors 58 are configured to provide a signal (e.g., wirelessly, including using Bluetooth, 802.11, near-field communications, etc., or over a wired medium, including via a controller area network (CAN) bus or busses) to the controller 60. The controller 60 receives the signal and determines a value for a suitable float pressure adjustment for the hydraulic float assembly 26 (e.g., the fluid pressure for the hydraulic cylinders 28) and signals the manifold 34 to cause that adjustment (e.g., by changing the fluid flow to and/or from the hydraulic cylinders 28). The windrower 10 also comprises a user interface 62, which may comprise a display screen, a FNR handle or joystick, buttons, knobs, lever switches, headset, microphone, etc. Input entered at the user interface 62 may be received by the controller 60 and acted upon. For instance, the operator may vocalize or physically enter an instruction (or select an option) to adjust the skid plate positions (e.g., height). The controller 60, responsive to the instructions, signals the manifold 34 to adjust the flow into or out of the skid plate actuators 36, which in turn causes adjustment of the position of the skid plates 56. In some embodiments, the input to the controller 60 may be via another component or interface, such as from memory over a data bus based on access to a local or remote data structure upon the detection of a particular field location and/or crop type. Access may be to a value for an appropriate setting suitable for the location or crop (e.g., based on prior skid position settings).

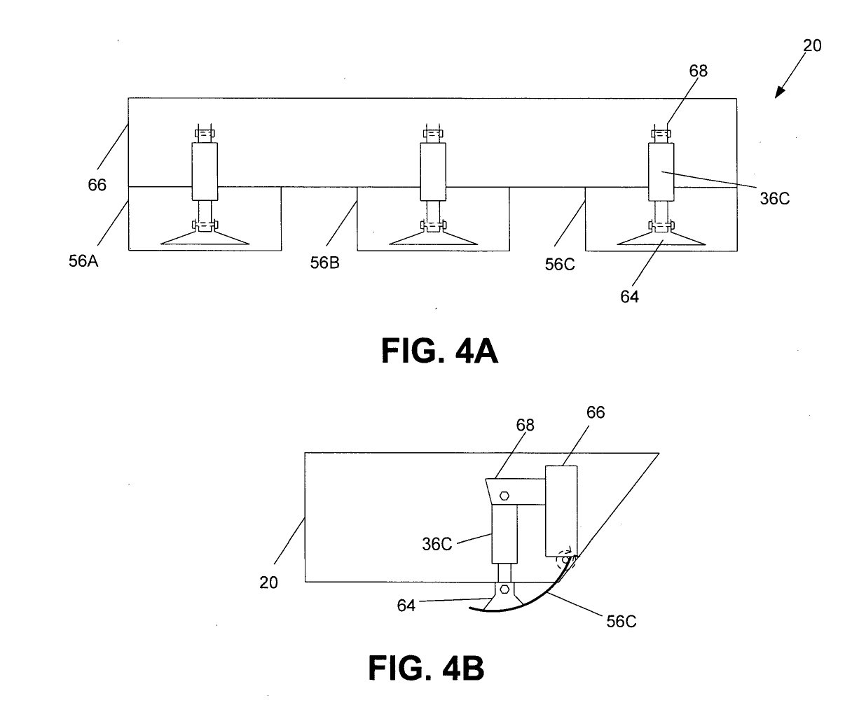

Having described an embodiment of an example windrower 10 having a header adjust system, attention is directed to FIGS. 4A-4B, which illustrate in rear and side elevation fragmentary views, respectively, the header 20 with plural skid plates 56 and associated skid plate actuators 36. It should be appreciated by one having ordinary skill in the art that the placement and/or quantity or structural arrangement is one example, and that some embodiments may use fewer or additional skid plates with the same or different mounting configuration than that depicted in FIGS. 4A-4B. In this example, the skid plates 56 are mounted forwardly and at a lower end of the header 20, and positioned on opposing sides of the header 20 and centrally. Referring to the right-most skid plate 56C in FIG. 4A, with the understanding that a similar description applies to the other skid plates 56A and 56B and associated components, one mounting end of a skid plate actuator 36C is mounted proximal to a lower end of the skid plate 56C via a lower bracket 64. The lower bracket 64 may be welded to the upper surface of the skid plate 56C, or attached according to other known securing mechanisms. The bracket 64 has two (2) walls extending rearwardly from a rear-facing side of the skid plate 56A and has respective, aligned mounting holes through the two walls. One mounting end of the skid plate actuator 36C fits between the two walls of the bracket 64 and is secured in that position by a bolt (or rod or pin) that extends transversely (e.g., to the direction of forward movement of the windrower 10) through a mounting hole (or holes depending on the mounting configuration of the skid plate actuator 36C) of the one mounting end of the skid plate actuator 36A and through the two holes in the respective walls of the bracket 64. The bolt is secured in position according to known securing means, including using a nut. The skid plate actuator 36C is further secured to a transverse-extending frame member 66 of the header 20 via an upper bracket 68 which has two walls protruding rearwardly and further comprises aligned mounting holes. The bracket 68 may be welded to the frame member 66 or attached via other known attachment or securing mechanisms. The other mounting end of the skid plate actuator 36C fits between the two walls and likewise has one or two mounting holes. A bolt (or rod or pin) fits through the holes of the walls of the bracket 68 and the upper end of the skid plate actuator 36C (transversely) and is secured there by a securing means (e.g., a nut). Referring in particular to FIG. 4B, the skid plate 56C has a curvilinear shape, somewhat similar when viewed in side elevation view to a snowmobile ski. The lower portion of the skid plate 56C is approximately level to the surface and the lower bracket 64 sets upon the top surface of the skid plate 56C. In one embodiment, the upper portion of the skid plate 56C is positioned proximal to the frame member 66 and is pinned to the frame in hinge-like or pivotal manner (as represented by the dual-headed arrow) to enable adjustment of the skid plate 56C via actuation of the skid plate actuator 36C. Note that other known structural mechanisms may be used to achieve the freedom of movement of the skid plate 56C, as should be appreciated by one having ordinary skill in the art.

In one example operation (viewing the skid plate movement from the perspective of operations by one skid plate actuator, with the understanding that all operations are in unison at each skid plate 56 using parallel control), when the header is raised form the ground surface, an operator inputs an instruction (e.g., via selection of a skid plate height option, verbal command, etc.) causing the actuation of the skid plate actuator 36 against the fixed frame member 66 (e.g., by virtue of its connection via the upper bracket 68 and pinned connection). The action of the skid plate actuator 36, by virtue of its connection to the fixed upper bracket 68 and connection to the lower portion of the skid plate 56 (via the bracket 64) and the pivotal connection at the upper surface of the skid plate 56, causes the raising or lowering of the skid plate 56 relative to the ground surface. The adjustments may be discrete interval settings in height, or in some embodiments, continual adjustments (e.g., not discrete). In some embodiments, as set forth above, the input to trigger the raising or lowering of the skid plates 56 may be via detection (or input) of a particular crop or field location and use of a height setting that historically has been used for the field or crop or based on real-time information about crop conditions (e.g., crop height, current header height, wind conditions, etc.). By using skid plate actuators 36 for adjustment of skid plate positioning, an operator need not leave the cab of the windrower 10, saving time and improving operator safety by also avoiding undesirable environmental and/or machine conditions or risking accidental injury with a raised header 20.

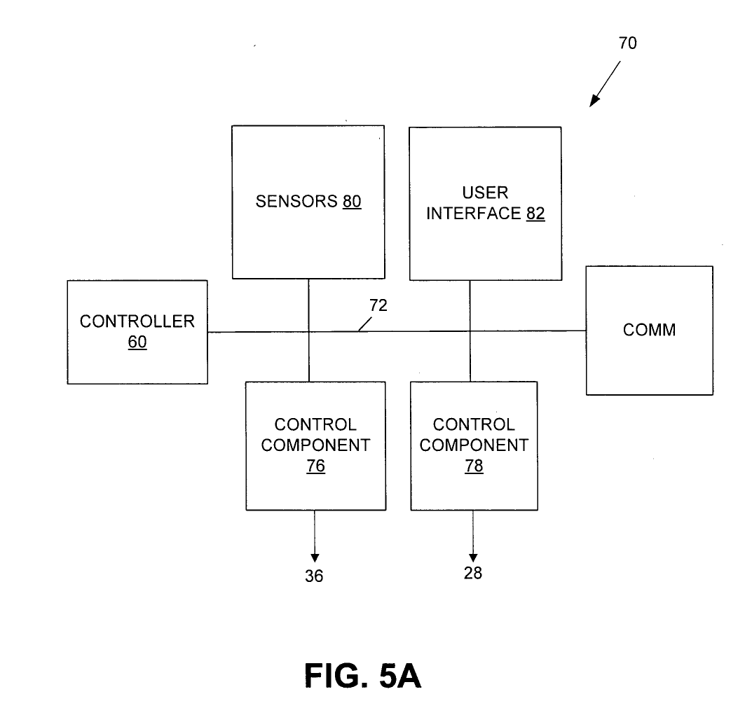

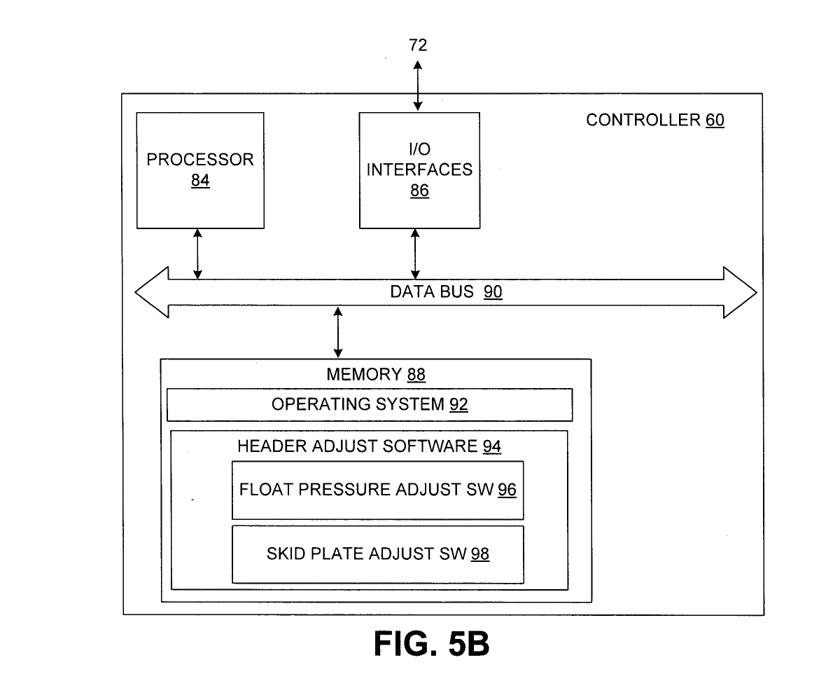

Reference is now made to FIG. 5A, which illustrates an embodiment of an example control system 70 used for providing control and management of header adjust system. It should be appreciated within the context of the present disclosure that some embodiments may include additional components or fewer or different components, and that the example depicted in FIG. 5A is merely illustrative of one embodiment among others. Further, though depicted as residing entirely within the windrower 10, in some embodiments, the control system 70 may be distributed among several locations. For instance, the functionality of the controller 60 may reside all or at least partly at a remote computing device, such as a server that is coupled to the control system components over one or more wireless networks (e.g., in wireless communication with the windrower 10 via a radio frequency (RF) and/or cellular modems residing in the windrower 10). Further, though depicted using a single controller 60, in some embodiments, the control system 70 may be comprised of plural controllers. In the depicted embodiment, the controller 60 is coupled via one or more networks, such as network 72 (e.g., a CAN network or other network, such as a network in conformance to the ISO 11783 standard, also referred to as “Isobus”), to control components 76, 78, sensors 80, and a user interface 82. Note that control system operations are primarily disclosed herein in the context of control via the single controller 60, with the understanding that additional controllers may be involved in one or more of the disclosed functionality in some embodiments.

The control component 76 comprises components used to control operations of the skid plate actuators 36. The control may be the regulation of fluid (e.g., hydraulic fluid) flow into and out of the skid plate actuators 36, or depending on the technology used for the skid plate actuator 36, may switch current or voltage on or off (or modulate the same), such as for an electric or electromagnetic or magnetic actuator, or regulate the flow of air for a pneumatic actuator, which may still involve voltage or current control. The control component 76 may comprise a control valve, motor control logic, an air valve, a solenoid, among other controlling devices or components.

The control component 78 comprises components used to control float operations of the hydraulic cylinders 28, which generally comprises controlling the flow of hydraulic fluid through the hydraulic cylinders 28. Although described as control for hydraulic cylinders 28 (e.g., using control valves), the control component 78 may be comprised of other technologies, similar to that described for control component 76. In some embodiments, the control components 78 may include control components of the manifold 34, as described above, though in some embodiments, separate manifolds with control valves, etc. may be used for the float pressure control and the skid adjustment functionality.

The sensors 80 include one or any combination of the GNSS receiver 24, the sensors 58 (including pressure or position/distance sensors), micro-switches, potentiometers, load sensors, drag-type sensors, etc. The sensors 80 may monitor parameters including pressure or load on the header 20, and in particular, on the skid plates 56. The sensors 80 may monitor the parameter of a change in gap between the ground surface and the header bottom or the skid plates 56 and/or a distance. For instance, one of the sensors 80 may be configured as a micro-switch that changes state when the header 20 is lifted from the ground surface. One or more of the sensors 80 may be standalone devices that are attached to the header 20 or skid plates 56, and in some embodiments, one or more of the sensor 80 may be coupled to, or integrated within, components. For instance, each of the skid plate actuators 36 may comprise an integrated pressure switch or distance measurement sensor. In some embodiments, only one of the skid plate actuators 36 is so-equipped. The sensors 80 may be embodied as contact (e.g., electromechanical sensors, such as position sensors, strain gauges, pressure sensors, distance measurement, etc.) and non-contact type sensors (e.g., photo-electric, inductive, capacitive, ultrasonic, etc.), all of which comprise known technology.

The user interface 82 may include one or more components, including one or any combination of a keyboard, mouse, microphone, touch-type or non-touch-type display device (e.g., display monitor or screen), joystick, steering wheel, FNR lever, and/or other devices (e.g., switches, immersive head set, etc.) that enable input and/or output by an operator. For instance, in some embodiments, the user interface 82 may be used to present plural user-selectable skid plate height adjust settings for the operator to choose from, or the user interface 82 may provide feedback of when the header float position has changed (or recommendations to change) during operation and/or when pressure on the skid plates 56 is beyond recommended levels.

The control system 70 may include one or more additional components, such as a communications module that comprises a wireless network interface module (e.g., including an RF or cellular modem) for wireless communication among other devices of the windrower 10 or other communication devices located remote and/or external from the windrower 10. The communications module may work in conjunction with communication software (e.g., including browser software) in the controller 60, or as part of another controller coupled to the network 72 and dedicated as a gateway for wireless communications to and from the network 72. The communications module may comprise MAC and PHY components (e.g., radio circuitry, including transceivers, antennas, etc.), as should be appreciated by one having ordinary skill in the art.

FIG. 5B further illustrates an example embodiment of the controller 60. One having ordinary skill in the art should appreciate in the context of the present disclosure that the example controller 60 is merely illustrative, and that some embodiments of controllers may comprise fewer or additional components, and/or some of the functionality associated with the various components depicted in FIG. 5B may be combined, or further distributed among additional modules, in some embodiments. It should be appreciated that, though described in the context of residing in the windrower 10 (FIG. 1), in some embodiments, the controller 60, or all or a portion of its corresponding functionality, may be implemented in a computing device or system located external to the windrower 10. Referring to FIG. 5B, with continued reference to FIG. 5A, the controller 60 or electronic control unit (ECU) is depicted in this example as a computer, but may be embodied as a programmable logic controller (PLC), field programmable gate array (FPGA), application specific integrated circuit (ASIC), among other devices. It should be appreciated that certain well-known components of computers are omitted here to avoid obfuscating relevant features of the controller 60. In one embodiment, the controller 60 comprises one or more processors (also referred to herein as processor units or processing units), such as processor 84, input/output (I/O) interface(s) 86, and memory 88, all coupled to one or more data busses, such as data bus 90. The memory 88 may include any one or a combination of volatile memory elements (random-access memory RAM, such as DRAM, and SRAM, etc.) and nonvolatile memory elements (e.g., ROM, Flash, hard drive, EPROM, EEPROM, CDROM, etc.). The memory 88 may store a native operating system, one or more native applications, emulation systems, or emulated applications for any of a variety of operating systems and/or emulated hardware platforms, emulated operating systems, etc.

In the embodiment depicted in FIG. 5B, the memory 88 comprises an operating system 92 and header adjust software 94, which includes float pressure adjust software (SW) 96 and skid plate adjust software (SW) 98. It should be appreciated that in some embodiments, additional or fewer software modules (e.g., combined functionality) may be deployed in the memory 88 or additional memory. In some embodiments, a separate storage device may be coupled to the data bus 90, such as a persistent memory (e.g., optical, magnetic, and/or semiconductor memory and associated drives).

The header adjust software 94 receives sensor input from one or more of the sensors 80 and input over the network 72 from the user interface 82 via the I/O interfaces 86. The header adjust software 94 communicates control signals to the control components 76, 78 via the I/O interfaces 86 and the network 72. The communications may be performed wirelessly in some embodiments, or over a wired medium such as when the network 72 is implemented as a CAN bus. The sensors 80 may communicate various parameters, including location coordinates, imaging data, skid pressure or load, skid and/or header gap distance relative to the ground surface (including gap changes), environmental conditions, including weather conditions, among other parameters.

In one embodiment, the processor 84 of the controller 60, executing the float pressure adjust software 96, operates in conjunction with the sensors 80 and control component 78 to adjust the float pressure of the hydraulic float assembly 26. For instance, for stationary settings, the operator (via commands entered at the user interface 82) causes the header to be raised (or the header may be raised automatically based on detection of entrance to the field). A sensor 80, such as a micro-switch, an integral sensor to the skid plate actuator 36, or a potentiometer attached to a drag rod underneath the header 20, may switch operational state upon detecting a gap between the header bottom surface (or the skid plate bottom surface) and the ground surface. The switched operational state is detected by (or signaled to) the controller 60, which in turn communicates to the control component 78 to adjust the float pressure to one or more interval settings lower (e.g., 100-200 lbs.) or as needed for the particular field location (as detected via the GNSS sensor or receiver 24) or based on the type of crop detected (e.g., via imaging or based on operator input of field conditions or crop type) or inputted. In some embodiments, as set forth above, one of the sensors 80 may be integral to the skid plate actuator 36, which upon detecting zero pressure on the skid plate 56 (corresponding to the header 20 being raised off the ground surface), triggers a similar automatic adjustment in float pressure setting. In some embodiments, the float pressure adjust software 96 may receive on-going updates of the skid plate pressures or header-to-surface gaps while traversing through a field. Such updates may be useful for more efficient operations in the field. For instance, the sensors 80 used in conjunction with the skid plate actuators 36 or skid plates 56 may sense during field operations if there is excessive pressure on the skid plates 56 or if there is insufficient pressure on the skid plates 56. In some instances, an operator may decrease the float pressure if the header 20 is being pushed up by higher crop, though if by doing so, the skid plates 56 receive an excessive load, the controller 60 may receive the pressure indications from the sensors 80 and alert the operator of this condition. In some embodiments, more active control may occur, such as where the sensors 80 indicate that an increased gap between the ground surface and the header 20 is rendering operations inefficient, and hence the float pressure adjust software 96 executing on the processor 84 of the controller 60 may reduce the float pressure to place more weight on the header 20 to prevent the migration upwards due to the types of crop influencing that increased gap. Similarly, the sensors 80 may detect that pressures or load on the skid plates 56 during field operations is excessive, and the float pressure adjust software 96 executing on the processor 84 of the controller 60 reacts by increasing the float pressure to reduce the load on the skid plates 56.

In one embodiment, the skid plate adjust software 98, executing on the processor 84 of the controller 60, operates in conjunction with the control component 76 and the user interface 82 to adjust the skid plate positioning. For instance, an operator, upon entering a field, may be presented with, or may invoke, a user screen interface that presents plural options for skid plate height adjustment. In some embodiments, graphical user interface (GUI) functionality of the skid plate adjust software 98 may recommend a setting change (if needed) based on historical use for that field or based on crop type, or in some embodiments, the adjustments may occur without operator input (e.g., based on detection of the field location, the crop type), and the skid plate adjust software 98 makes the adjustment based on feedback of the current skid plate position as rendered by the sensor 80. Based on the input (either via the operator selection or as programmatically detected), the skid plate adjust software 98, through the processor 84 and I/O interfaces 86, signals to the control component 76, which in turn causes fluid flow changes to the skid plate actuators 36. By actuating the skid plate actuators 36, the skid plates 56 are raised or lowered according to the required setting without the operator leaving the cab 16.

Execution of the header adjust software 94, including the float pressure adjust software 96 and the skid plate adjust software 98, may be implemented by the processor 84 under the management and/or control of the operating system 92. The processor 84 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the controller 60.

The I/O interfaces 86 provide one or more interfaces to the network 72 and other networks. In other words, the I/O interfaces 86 may comprise any number of interfaces for the input and output of signals (e.g., analog or digital data) for conveyance of information (e.g., data) over the network 72. The input may comprise input by an operator (local or remote) through the user interfaces 82 and input from signals carrying information from one or more of the components of the control system 70, such as the sensors 80.

When certain embodiments of the controller 60 are implemented at least in part with software (including firmware), as depicted in FIG. 5B, it should be noted that the software can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiment of the controller 60 are implemented at least in part with hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

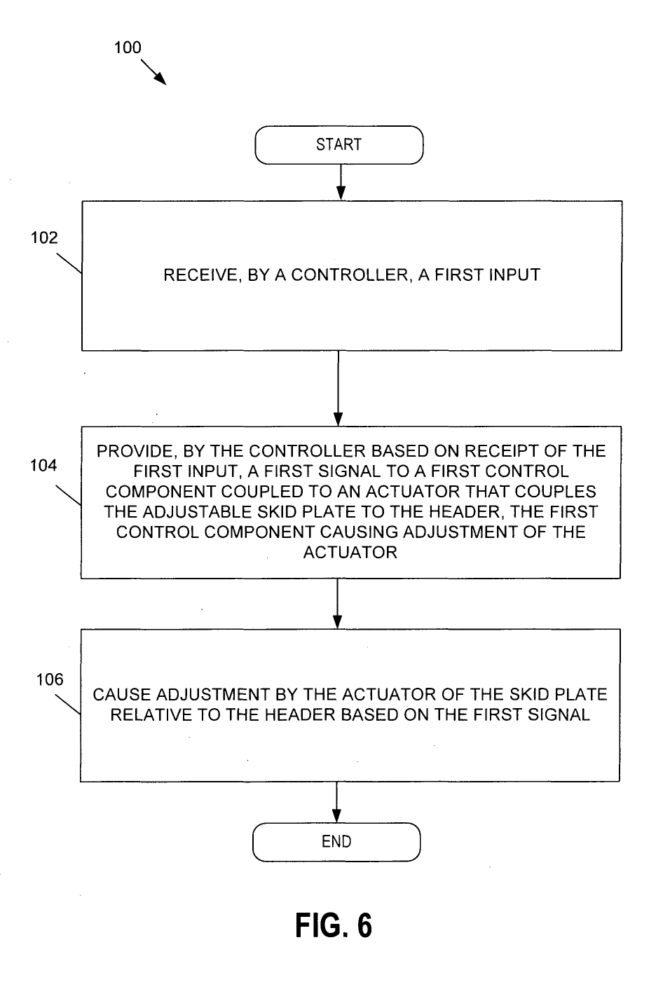

In view of the above description, it should be appreciated that one embodiment of a header adjust method 100 for implementation on a machine comprising a hydraulic float assembly having plural float cylinders and a header coupled to the hydraulic float assembly, the header comprising at least one adjustable skid plate, depicted in FIG. 6 (and implemented in one embodiment by the header adjust software 94, FIG. 5B), comprises: receiving, by a controller, a first input (102); providing, by the controller based on receipt of the first input, a first signal to a first control component coupled to an actuator that couples the adjustable skid plate to the header, the first control component causing adjustment of the actuator (104); and causing adjustment by the actuator of the skid plate relative to the header based on the first signal (106).

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein. Although the control systems and methods have been described with reference to the example embodiments illustrated in the attached drawing figures, it is noted that equivalents may be employed and substitutions made herein without departing from the scope of the disclosure as protected by the following claims.

At least the following is claimed:

1. A machine, comprising:
a chassis supporting a hydraulic float assembly, the hydraulic float assembly comprising first plural cylinders and a first control component;
a header coupled to the hydraulic float assembly, the header comprising:
a frame comprising processing components on an upper side of the frame and plural skid plates on a lower side of the frame, the plural skid plates adjustably coupled to the frame via respective second plural cylinders; and
a controller configured to:
receive a first input; and
provide a first signal to a second control component coupled to the second plural cylinders based on the first input, the second control component configured to adjust fluid flow through the second plural cylinders based on the first signal, the second plural cylinders causing adjustment of a position of the plural skid plates based on the adjusted fluid flow.

2. The machine of claim 1, further comprising a user interface, wherein based on operator input at the user interface, the first input is transmitted to the controller.

3. The machine of claim 1, further comprising one or more sensors.

4. The machine of claim 3, wherein the controller is further configured to:
receive a signal or signals from the one or more sensors; and
provide a second signal to the first control component based on the signal or signals from the one or more sensors, the first control component configured to adjust flow fluid through the first plural cylinders based on the second signal, the first plural cylinders causing adjustment of a float position of the header based on the adjusted flow through the first control component.

5. The machine of claim 4, further comprising a user interface, wherein the controller is further configured to provide feedback of the adjustment or recommend the adjustment via the user interface.

6. The machine of claim 3, wherein the one or more sensors are attached to or integrated with one or more of the second plural cylinders.

7. The machine of claim 3, wherein the one or more sensors are attached to the frame or the plural skid plates.

8. The machine of claim 3, wherein the one or more sensors are configured to detect a force on the plural skid plates.

9. The machine of claim 3, wherein the one or more sensors are configured detect a distance or change in gap between the plural skid plates and a ground surface.

10. The machine of claim 3, wherein the one or more sensors comprise non-contact type sensors.

11. The machine of claim 3, wherein the one or more sensors comprise contact type sensors.

12. A method for implementation on a machine comprising a hydraulic float assembly having plural float cylinders and a header coupled to the hydraulic float assembly, the header comprising at least one adjustable skid plate, the method comprising:
receiving, by a controller, a first input;
providing, by the controller based on receipt of the first input, a first signal to a first control component coupled to an actuator that couples the adjustable skid plate to the header, the first control component causing adjustment of the actuator; and
causing adjustment by the actuator of the skid plate relative to the header based on the first signal.

13. The method of claim 12, wherein receiving a first input comprises receiving the first input based on operator input at a user interface.

14. The method of claim 12, wherein receiving a first input comprises receiving information about a crop type or a current location of the machine.

15. The method of claim 12, wherein the first control component comprises a control valve, a solenoid valve, or a motor control component.

16. The method of claim 12, wherein the actuator comprises a cylinder or a motor.

17. The method of claim 12, further comprising detecting with a sensor a parameter, the parameter comprising one of a force on the skid plate or a change in gap between the skid plate and a ground surface.

18. The method of claim 17, further comprising adjusting a float position of the header by actuating the plural float cylinders based on the detected parameter.

19. The method of claim 18, wherein detecting is based on using a sensor attached to or integrated with the actuator.

20. A non-transitory computer readable medium comprising instructions that are executed by one or more processors to:
receive an input;
provide, based on the input, a first signal to a first control component coupled to an actuator that couples an adjustable skid plate to a header, the first control component causing adjustment of the actuator; and
causing adjustment by the actuator of the skid plate relative to the header based on the first signal.
